(19) United States
(12) Patent Application Publication
(10) Pub. No.: US 2008/0273762 A1
(43) Pub. Date: Nov. 6, 2008

(54) Image Determination Device, Image Determination Method, and Program

(76) Inventor: Yumi KATO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/034,364

(22) Filed: Feb. 20, 2008

(30) Foreign Application Priority Data
Feb. 26, 2007 (JP) P2007-046123

(51) Int. Cl. G06K 9/78

(52) U.S. Cl. 382/115

(57) ABSTRACT

An image determination device according to the present invention includes: an extraction means for extracting a figuration pattern of an identification subject in a finger reflected on an image; a detection means for detecting a joint line in the finger; and a determination means for determining the image as an image to be registered or an image to be collated with a registration subject when a joint line exists in a first range which is set in one of respective regions obtained when separating the image with the center line that corresponds to a direction perpendicular to the longitudinal direction of the finger and that is set as the border, and a blood vessel amount which is equal to or more than a predetermined threshold value exists in a second range which is set in the other region different from the region in which the first range is set.

### CROSS REFERENCES TO RELATED APPLICATIONS

The present invention contains subject matter related to Japanese Patent Application JP2007-046123 filed in the Japanese Patent Office on Feb. 26, 2007, the entire contents of which being incorporated herein by reference.

### BACKGROUND OF THE INVENTION

1. Field of the Invention This invention relates to an image determination device, an image determination method, and a program, which are desirably applied to the biometric authentication.

2. Description of the Related Art

As one of biometric authentication subjects, a blood vessel has been employed. In the blood vessel, the deoxygenated hemoglobin (venous blood) and oxygenated hemoglobin (arterial blood) are provided with properties of specifically absorbing light in the near-infrared light band (near infrared ray), and, by utilizing the properties, an image of a blood vessel of a finger is picked up.

As a method to direct a finger toward the image pickup range, there has been suggested a method in which an image of a finger placed on a finger placement table is picked up, and, with the first joint and second joint is from the fingertip in the picked up image set as the criteria, it is determined whether or not the finger is set within the image pickup range, and a guidance to pick up an image of the finger again is displayed according to the determination result (for example, refer to Patent Document 1; Registration of Utility Model Mo. 3100993).

### SUMMARY OF THE INVENTION

Meanwhile, in case of obtaining a constant resolution, setup of the image pickup range becomes an important factor in terms of downsizing. In this regard, as for the above-described direction method, in determining whether or not the finger is set on the suitable position within the image pickup range by using an image, since the existence of the first joint and second joint is set as the criteria, there is a problem that an image pickup range which is equal to or more than a range which can set the finger from the first joint to the second joint thereof needs to be arranged.

In view of the above-identified circumstances, it is therefore desirable to provide an image determination device, an image determination method, and a program, which can improve the degree of freedom in setting the image pickup range.

According to an embodiment of the present invention, there is provided an image determination device including: an extraction means for extracting a figuration pattern of an identification subject in a finger reflected on an image; a detection means for detecting a joint line in the finger; a determination means for determining the image as an image to be registered or an image to be collated with a registration subject when a joint line exists in a first range which is set in one of respective regions obtained when separating the image with the center line that corresponds to a direction perpendicular to the longitudinal direction of the finger and that is set as the border, and a blood vessel amount which is equal to or more than a predetermined threshold value exists in a second range which is set in the other region different from the region in which the first range is set.

According to an embodiment of the present invention, there is also provided an image determination method including: a first step of setting a first range in one of respective regions obtained when separating an image with the center line that corresponds to a direction perpendicular to the longitudinal direction of a finger reflected on the image and that is set as the border, and, in case a joint line of the finger does not exist in the set first range, setting the first range in the other region of the respective regions; a second step of, when the joint line exists in the first range, setting a second range in the other region different from the region in which the first range is set; and a third step of, when the joint line exists in the first range, and a blood vessel amount which is equal to or more than a predetermined threshold value exists in the second range, determining the image as an image to be registered or an image to be collated with a registration subject.

According to an embodiment of the present invention, there is also provided a program that makes a control unit controlling a work memory execute: setting a first range in one of respective regions obtained when separating an image input to the control unit with the center line that corresponds to a direction perpendicular to the longitudinal direction of a finger reflected on the image and that is set as the border, and, in case a joint line of the finger does not exist in the set first range, setting the first range in the other region of the respective regions; when the joint line exists in the first range, setting a second range in the other region different from the region in which the first range is set; and when the joint line exists in the first range, and a blood vessel amount which is equal to or more than a predetermined threshold value exists in the second range, determining the image as an image to be registered or an image to be collated with a registration subject.

As described above, according to the present invention, when a joint line exists in a predetermined position (first range) set in one region side of an image, it can be determined whether or not the joint line is a line corresponding to the second joint of a finger according to the degree of a blood vessel amount in a predetermined position (second range) set in the other region side.

Accordingly, even if the image pickup range does not have a range in which part of a finger from the first joint to the second joint is set in, the authentication device 1 can determine whether or not a region near the second joint between the first joint and the second joint is located at the center of an image by the existence of a joint line, and thus, an image determination device, an image determination method, and a program capable of improving the degree of freedom in setting the image pickup range can be realized.

The nature, principle and utility of the present invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 shows a block diagram indicative of the entire configuration of an authentication device according to an embodiment of the present invention;

FIG. 2 shows a block diagram indicative of the functional configuration of the image processing in a control unit;

FIGS. 3A and 3B show schematic views indicative of images before and after the pattern extraction;

FIG. 4 shows a schematic view to explain the specification order of a focused pixel;

FIGS. 5A to 5C show schematic views to describe the replacement of a luminance;

FIGS. 6A and 6B show schematic views indicative of images before and after the noise elimination;

FIG. 7 shows a schematic view indicative of a difference image between an image before eliminating transverse wrinkle components and an image after the elimination;

FIG. 8 shows a schematic view indicative of an image from which the protrusion parts of the transverse wrinkle components are eliminated;

FIG. 9 shows a schematic view indicative of an image in which the linear components having high continuity are left;

FIG. 10 shows a schematic view to illustrate setup of a joint line detection range;

FIG. 11 shows a flowchart indicative of the image determination processing procedure;

FIG. 12 shows a schematic view to illustrate setup of a. blood vessel amount detection range;

FIGS. 13A and 13B show schematic views indicative of a blood vessel amount in the blood vessel amount detection range in case the first joint exists in the joint line detection range;

FIGS. 14A and 14B show schematic views indicative of a blood vessel amount in the blood vessel amount detection range in case the second joint exists in the joint line detection range;

FIGS. 15A and 15B show schematic views indicative of the comparison of a joint line reflected on a picked up image and a pattern extraction image between a case in which the joint is bent and a case in which the joint is extended;

FIGS. 16A to 16C show schematic views to illustrate detection of a joint line in another embodiment;

FIGS. 17A to 17C show the waveform patterns of a luminance histogram in an image.

### DETAILED DESCRIPTION OF THE PREFERRED EMBODIMENTS

Now, embodiments of the present invention will be described in greater detail by referring to the accompanying drawings.

### (1) Entire Configuration of Authentication Device

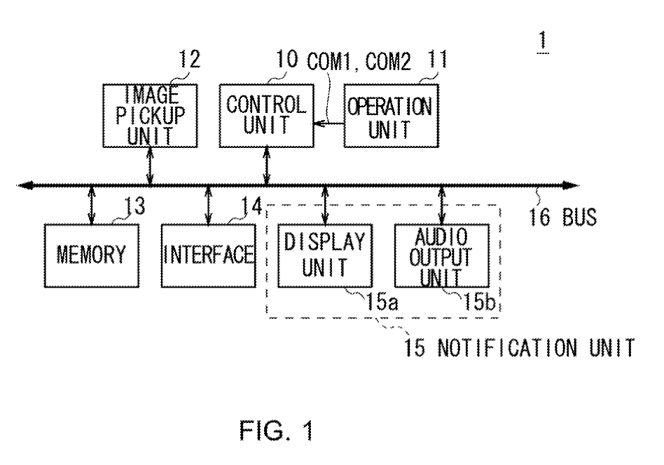

FIG. 1 shows the entire configuration of an authentication device 1 in this embodiment. The authentication device 1 includes a control unit 10, and further includes an operation unit 11, an image pickup unit 12, a memory 13, an interface 14, and a notification unit 15, which are connected to the control unit 10 through a bus 16, respectively.

The control unit 10 is configured as a computer that includes a central processing unit (CPU) which controls the entire authentication device 1, a read only memory (ROM) which stores various programs and setup information, and a random access memory (RAM) which works as a work memory for the CPU.

To the control unit 10, an execution command COM1 for a mode (referred to as blood vessel registration mode, hereinafter) to register a blood vessel of a user to be registered (referred to as registrant, hereinafter), or an execution command COM2 for a mode (referred to as authentication mode, hereinafter) to determine the existence or absence of the registrant is input from the operation unit 11 according to the user operation.

The control unit 10 determines the mode to he executed based on the execution commands COM1, COM2, and, based on a program corresponding to the determination result, arbitrarily controls the image pickup unit 12, memory 13, interface 14, and notification unit 15, and execute the blood vessel registration mode or authentication mode.

The image pickup unit 12 has a camera which sets a space over an area of the housing of the authentication device 1, on which a finger is placed, as the image pickup space, and adjusts the lens position of the optical system or the camera, the diaphragm value of the diaphragm, and the shutter speed (exposure time) of the image pickup element using an exposure value (EV) set up by the control unit 10 as a criterion.

The image pickup unit 12 has a near infrared light source that irradiates a near infrared ray to the image pickup space, and turns on the near infrared light source for a time period specified by the control unit 10, and picks up images of an image pickup subject which are reflected on the image pickup surface of the image pickup element every predetermined cycle, and outputs image data related to images generated as the image pickup result to the control unit 10 in series.

The memory 13 is, for example, a flash memory, and stores or reads out data specified by the control unit 10.

The interlace 14 sends and receives various data to and from an external device connected to the authentication device 1 through a predetermined transmission path.

The notification unit 15 includes a display unit 15a and an audio output unit 15b, and the display unit 15a displays characters and figures based on display data sent from the control unit 10 on a display screen, while the audio output unit 15b outputs audio based on audio data sent from the control unit 10 from a speaker.

### (1-1) Blood Vessel Registration Mode

Next, the blood vessel registration mode will be described. When determining the blood vessel registration mode as a mode to be executed, the control unit 10 sets the operation mode to the blood vessel registration mode, and makes the notification unit 15 notify that a finger has to be arranged in the image pickup space.

At this time, the control unit 10 makes the camera arranged in the image pickup unit 12 pick up images, and turns on the near infrared light source arranged in the image pickup unit 12.

In this state, when a finger is arranged in the image pickup space, a near infrared ray which is irradiated from the near infrared light source and passes through the inside of the finger goes to the image pickup element through the optical system and diaphragm of the camera as light which projects a blood vessel, and an image of the blood vessel arranged in the inside of the finger is reflected on the image pickup surface of the image pickup element. Accordingly, in the image based on image data which is generated as the image pickup result by the image pickup unit 12, the blood vessel is reflected.

The control unit 10 performs predetermined image processing for the image data input from the image pickup unit 12 to generate data to be identified (referred to as identification data, hereinafter), and makes the memory 13 store the identification data for registration.

In this way, the control unit 10 can execute the blood vessel registration mode.

### (1-2) Authentication Mode

Next, the authentication mode will be explained. When determining the authentication mode as a mode to be executed, the control unit 10 sets the operation mode to the authentication mode, and makes the notification unit 15 notify that a finger has to be arranged in the image pickup space, and makes the camera arranged in the image pickup unit 12 pick up images, and turns on the near infrared light source.

The control unit 10 performs the same image processing as that performed in the blood vessel registration mode for the image data input from the image pickup unit 12 to generate identification data. Then, the control unit 10 collates thus generated identification data and the identification data stored in the memory 13, and, according to the degree of data correlation which is obtained as the collation result, determines whether or not a person can be approved as the registrant.

In this case, when it is determined that the person is unable to be approved as the registrant, the control unit 10 notifies the person of the disapproval visually as well as aurally through the display unit 15a and the audio output unit 15b. On the other hand, in case it is determined that the person can be approved as the registrant, the control unit 10 sends data indicative of the approval as the registrant to a device connected to the interface 14. With the data indicative of the approval as the registrant set as a trigger, the device connected to the interface 14 carries out predetermined processing, such as locking a door for a predetermined time period, or releasing a restricted operation mode. The processing should be executed when the authentication is successfully performed.

In this way, the control unit 10 can execute the authentication mode.

### (2) Specific Processing Contents of Image Processing

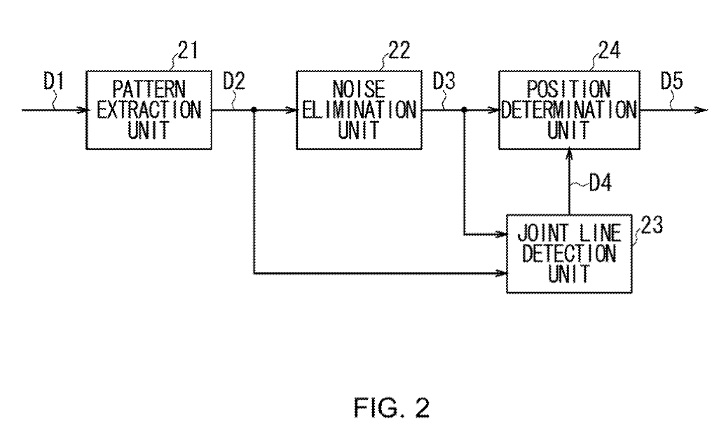

Next, image processing in the control unit 10 will be described. As shown in FIG. 2, functionally, the image processing is separately performed by a pattern extraction unit 21, a noise elimination unit 22, a joint line detection unit 23, and a position determination unit 24. Hereinafter, details of the pattern extraction unit 21, noise elimination unit 22, joint line detection unit 23, and position determination unit 24 will be explained.

### (2-1) Extracting Figuration Pattern of Blood Vessel

The pattern extraction unit 21 extracts a figuration pattern of a blood vessel reflected on an image represented by image data D1 input from the image pickup unit 12, and sends image data D2 related to an image in which the figuration pattern of the blood vessel is extracted to the noise elimination unit 22 and the joint line detection unit 23.

One example of the extraction method in the pattern extraction unit 21 will be explained. As preprocessing, the pattern extraction unit 21 highlights the contour reflected on the image, using a differentiation filter such as a Gaussian filter, a Log filter, etc. Furthermore, as preprocessing, the pattern extraction unit 21 corrects and rotates the image which has its contour highlighted such that the contour along the longitudinal direction of the finger comes to be parallel with the vertical direction (up and down direction) of the image, and cuts out an image of a region of a predetermined size with the center position set to the criterion from thus corrected and rotated image.

In this state, the pattern extraction unit 21 converts thus cut out image to a binary image with a set luminance value used as the criterion, and extracts the figuration pattern of the blood vessel as a line (referred to as blood vessel line, hereinafter) by detecting the center of width or the luminance peak of the width of a part (object) corresponding to the blood vessel reflected on the binary image.

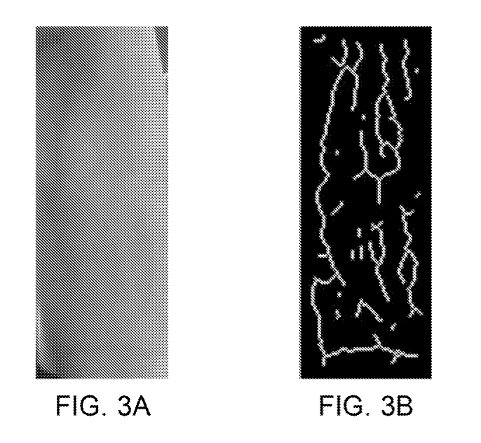

FIGS. 3A and 3B show images before and after the extraction under this extraction method. As is apparent from FIGS. 3A and 3E, the picked up image (FIG. 3A) is obtained as the binary image (FIG. 3B) which has its blood vessel part reflected on the image patterned in the form of a line.

### (2-2) Eliminating Noise

Of image (binary image) represented by the image data D2 sent from the pattern extraction unit 21, the noise elimination unit 22 eliminates components (referred to as transverse wrinkle components, hereinafter) corresponding to wrinkle (referred to as transverse wrinkles, hereinafter) along a direction perpendicular to the longitudinal direction of the finger as noise, and sends image data D3 related to the image which has its transverse wrinkle components eliminated to the joint line defection unit 23 and the position determination unit 24.

Longitudinal wrinkle components on the finger surface are not eliminated since, in general, there is a tendency that transverse wrinkles are more noticeable than wrinkles (longitudinal wrinkles) along the longitudinal direction of a finger.

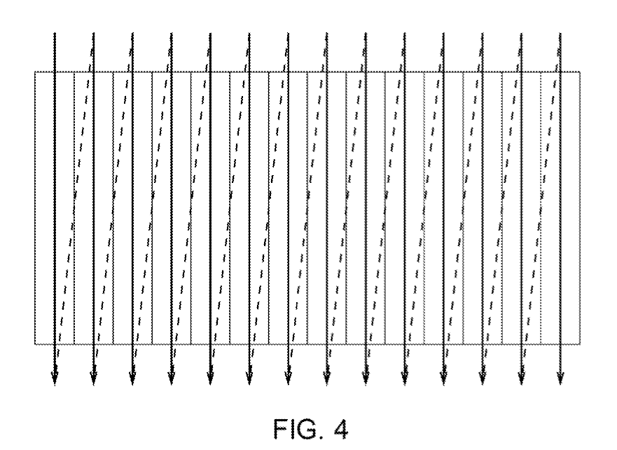

One example of the elimination method in the noise elimination unit 22 will be explained. For example, as shown in FIG. 4, of pixel columns along the vertical direction (up and down direction) corresponding to the longitudinal direction of the finger, from the left end column to the right end column in series, the noise elimination unit 22 sequentially specifies respective pixels in a corresponding pixel column as a focused pixel from the upper end in the downward direction, and changes the luminance value of thus specified focused pixel as necessary.

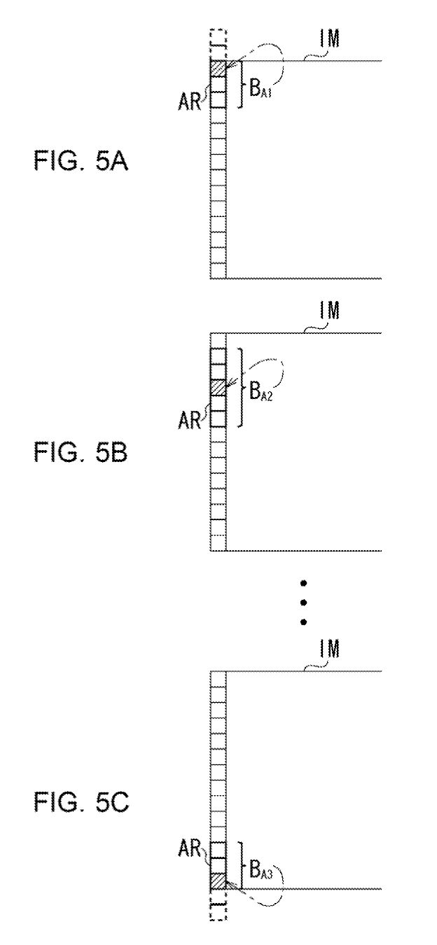

Specifically, for example, as shown in FIG. 5A, when specifying the left upper end pixel of the image as a focused pixel, the noise elimination unit 22 sets a range (referred to as five-pixel range, hereinafter) AR corresponding to five pixels continuing in the vertical direction with the focused pixel set to the center, and the luminance value of the left upper end pixel of the image is replaced with a luminance average value B_{A1} of three pixels existing in the five-pixel range AR.

Furthermore, for example, as shown in FIG. 5B, when specifying the fourth pixel of the image from the left upper end in the downward direction as a focused pixel, the noise elimination unit 22 sets the five-pixel range AR with the focused pixel set to the center, and the luminance value of the fourth pixel of the image from the left upper end in the downward direction is replaced with a luminance average value B_{A2} of five pixels existing in the five-pixel range AR.

Moreover, for example, as shown in FIG. 5C, when specifying the left lower end pixel of the image as a focused pixel, the noise elimination unit 22 sets the five-pixel range AR with the focused pixel set to the center, and the luminance value of the left lower end pixel of the image is replaced with a luminance average value B_{A3} of three pixels existing in the five-pixel range AR.

In this way, the noise elimination unit 22 specifies the respective pixels as a focused pixel, and disperses the transverse wrinkle components by replacing the luminance value of the focused pixel with a luminance average value of pixels of a predetermined number continuing in the vertical direction (up and down direction) with the focused pixel set to the center, thereby eliminating the transverse wrinkle components.

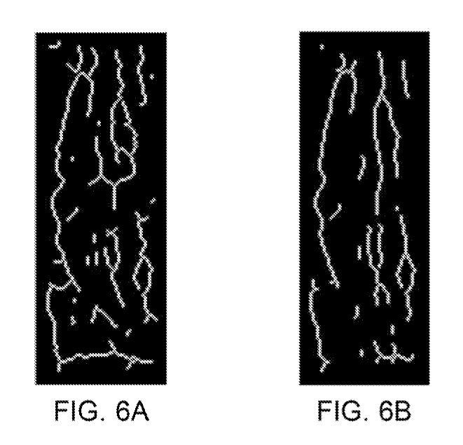

FIGS. 6A and 6E show images before and after the elimination under this elimination method. As is apparent when comparing the image before eliminating the transverse wrinkle components (FIG. 6A) and the image after eliminating the transverse wrinkle components (FIG. 6B), the transverse wrinkle components are smoothed to be eliminated.

### (2-3) Detecting Joint Line

Of transverse wrinkle components obtained from the difference between the image (FIG. 6A) represented by the image data D2 sent from the pattern extraction unit 21 and the image (FIG. 6B) represented by the image data D3 sent from the noise elimination unit 22, the joint line detection unit 23 detects wrinkle components which are high in continuity as a joint line, and sends position data D4 of thus detected joint line to the position determination unit 24.

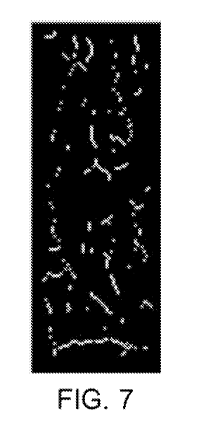

One example of the detection method in the joint line detection unit 23 will be explained. As shown in FIG. 7, the joint line detection unit 23 extracts transverse wrinkle components by calculating the difference between the image (FIG. 6A) from which a figuration pattern of a blood vessel is extracted and the image (FIG. 6B) in which transverse wrinkle components are eliminated from the image of FIG. 6A.

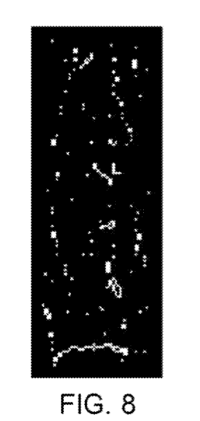

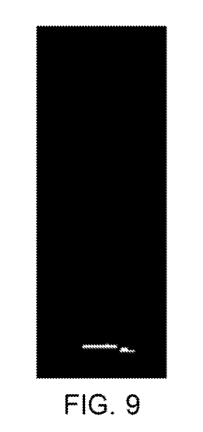

Then, as shown in FIG. 8, after eliminating protrusion parts of the transverse wrinkle components (FIG. 7) using a differentiation filter such as morphology, as shown in FIG. 9, the joint line detection unit 23 detects a joint line by leaving linear components which are high in continuity.

### (2-4) Determination of Right and Wrong of Finger Position in Image Pickup Range

Of the image represented by the image data D3 sent from the noise elimination unit 22, when a joint line of the finger exists in a first range which is set in one of respective regions obtained when separating the image with the center line corresponding to a direction perpendicular to the longitudinal direction of the finger set to the border, and a blood vessel amount which is equal to or more than a predetermined threshold value exists in a second range which is set in the other region different from the region in which the first range is set, the position determination unit 24 determines the image as an image to be registered or an image to be collated with a registration subject, and generates the image as identification data D5. The identification data D5 is registered in the memory 13 in case of the blood vessel registration mode, and is collated with identification data registered in the memory 13 in case of the authentication mode.

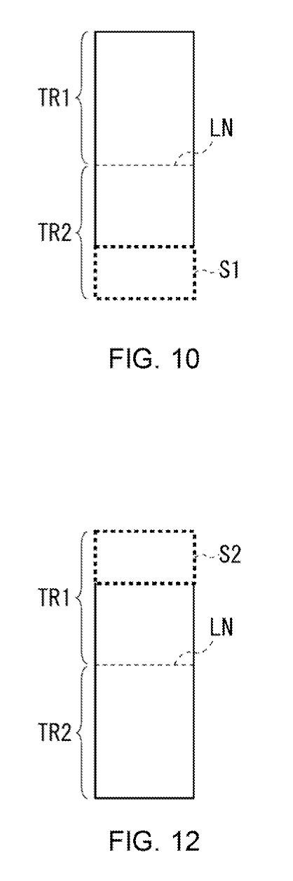

One example of the determination method in the position determination unit 24 will be explained. As shown in FIG. 10, of an upper region TR1 and a lower region TR2 separated with the center line LN corresponding to a direction perpendicular to the longitudinal direction of the finger set to the border, to a predetermined position of the lower region TR2, the position determination unit 24 sets a first range (referred to as joint line detection range, hereinafter) S1 to detect the existence of a joint line (FIG. 11: step SP1).

In FIG. 10, the joint line detection range S1 is in the form of a rectangle of ⅓ size with respect to the lower region TR2, and is set at the end of the lower region TR2. On the other hand, the figuration, size, and setup position of the joint line detection range S1 are arbitrarily determined based on the image size, part to be noticed as an identification subject in the finger region, etc.

Then, the position determination unit 24 recognizes a joint line from the position data D4 sent from the joint line detection unit 23, and, in case a joint line does not exist in the joint line detection range S1 (FIG. 11: step SP2 (NO)), sets the joint line detection range S1 to a position in the upper region TR1 which is symmetric with respect to the setup position in the lower region TR2 with the center line LN set to the symmetric axis (FIG. 11: step SP3).

In case a joint line does not exist in the joint line detection range S1 set in the upper region TR1 (FIG. 11: step SP4 (NO)), since the finger is not arranged in the suitable position in the image pickup range, or the image pickup environment is inferior, and accordingly a line does not exist at a predetermined position in the upper region TR1 and lower region TR2, or two or more lines exist therein, a joint line of the finger is unable to be recognized.

In this case, the notification unit 15 notifies contents that the arrangement position of the finger is largely distant from the suitable position in the image pickup range, or that the image pickup environment is inferior (FIG. 11: step SP5), and then, the position determination unit 24 repeats the above-described processing with the image data D3 sent from the noise elimination unit 22 set to a processing subject.

On the other hand, in case a joint line is detected in the joint line detection range S1 set in the lower region TR2 or in the upper region TR1 (FIG. 11: step SP2 (YES), or step SP4 (YES)), for example, as shown in FIG. 12, at a predetermined position of the upper region TR1 (or lower region TR2) which is different from the lower region TR2 (or upper region TR1) in which the joint line detection range S1 is set, the position determination unit 24 sets a second range (referred to as blood vessel amount detection range, hereinafter) S2 to detect the blood vessel amount (FIG. 11: step SP6).

In FIG. 12, the blood vessel amount detection range S2 is in the form of a rectangle of ⅓ size with respect to the upper region TR1 (or lower region TR2), and is set at the end of the upper region TR1 (or lower region TR2). On the other hand, the figuration, size, and setup position of the blood vessel amount detection range S2 are arbitrarily determined based on the image size, appearance direction of joint line, part to be focused as an identification subject in the finger region, etc., and may be equal to or different from those of the joint line detection range S1.

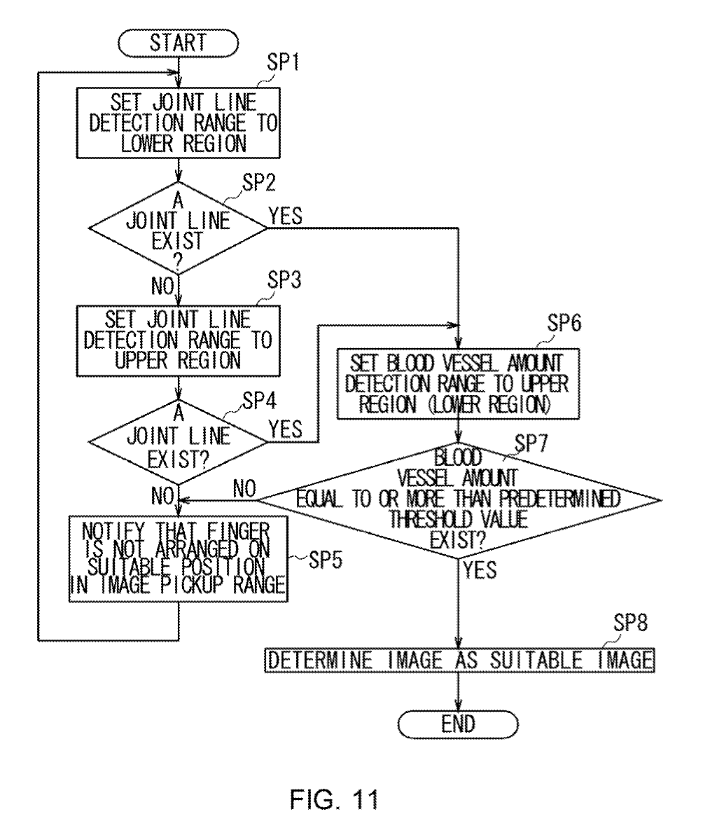

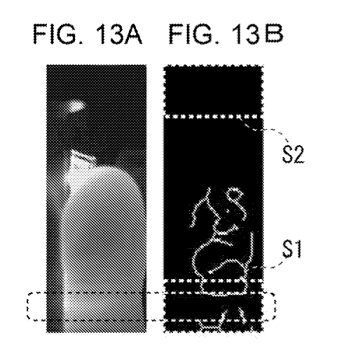

In case a blood vessel amount equal to or more than a predetermined threshold value does not exist in the blood vessel amount detection range S2 (FIG. 11: step SP7 (NO)), for example, as shown in FIGS. 13A and 13B, the joint line which exists in the joint line detection range S1 corresponds to the first joint of a finger (forefinger, middle finger, annular finger, little finger).

In this case, the notification unit 15 notifies contents that the arrangement position of the finger is slightly distant from the suitable position in the image pickup range (FIG. 11: step SP5), and repeats the above-described processing with the image data D3 sent front the noise elimination unit 22 set to a processing subject.

On the other hand, in case a blood vessel amount equal to or more than a predetermined threshold value exists in the blood vessel amount detection range S2 (FIG. 11: step SP7 (YES)), the joint line which exists in the joint line detection range S1 corresponds to the second joint, and, for example, as shown in FIGS. 14A and 14B, part of the finger between the first joint and the second joint where the amount of blood vessel is considered to be large is located at the center of the image. In this case, the position determination unit 24 determines the image as an image to be registered or an image to be collated with a registration subject.

### (3) Operation and Effect

In the above-described configuration, the authentication device 1 extracts a figuration pattern of a blood vessel of a finger reflected on an image (FIGS. 3A and 3B), and detects a joint line in the finger (FIG. 9).

Then, when a joint line exists in the joint line detection range S1 set up in the lower region TR2 (or upper region TR1) obtained when separated with the center line LN corresponding to a direction perpendicular to the longitudinal direction of the finger set to the border, and a blood vessel amount which is equal to or more than a predetermined threshold value exists in the blood vessel amount detection range S2 set in the upper region TR1 (or lower region TR2) (FIGS. 14A and 14B), the authentication device 1 determines the image as an image to be registered or an image to be collated with a registration subject.

When a joint line exists in the joint line detection range S1 located at the lower side of the image, the authentication device 1 can determine whether or not the joint line is the second joint line according to the degree of the blood vessel amount in the blood vessel amount detection range S2 located at the upper side of the image (FIGS. 13A and 13B, FIGS. 14A and 14B).

Accordingly, even if the image pickup range does not have a range in which part of a finger from the first joint to the second joint is set in, the authentication device 1 can determine whether or not a region near the second joint between the first joint and the second joint is located at the center of an image by the existence of a joint line, which can improve the degree of freedom in setting the image pickup range.

When the degree of freedom in setting the image pickup range is improved, since it becomes possible to flexibly correspond to a request of not forcing a person to fix a finger, a request on design, a request of reducing size, etc., the method which can determine whether or not a region near the second joint between the first joint and the second joint is located at the center of an image by the existence of a joint line becomes useful specifically.

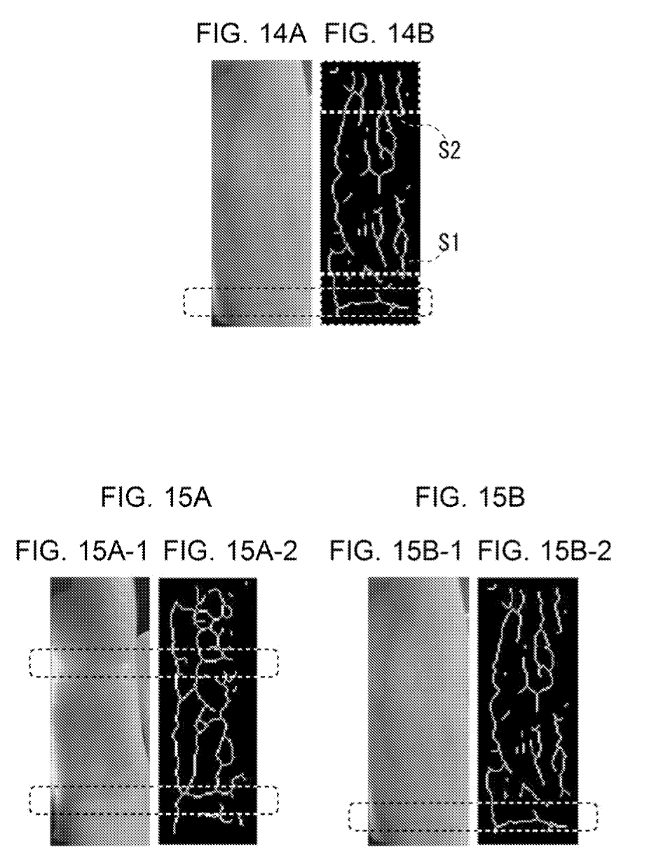

Furthermore, the authentication device 1 in this embodiment detects a joint line from an image from which a figuration pattern of a blood vessel is extracted (FIGS. 3A and 3B). For example, as shown in FIGS. 15A and 15B, depending on the performance of camera (image pickup condition), when an image is not picked up with a joint set in a bent state, a joint line may be unable to be reflected on a picked up image with a degree under which the joint line can be detected. Accordingly, as compared with a case of detecting a joint line in a picked up image, the authentication device 1 becomes useful in a point of being capable of detecting a joint line irrespective of the performance of camera (image pickup condition).

According to the above-described configuration, when a joint line exists in the joint line detection range S1 located at the lower side of the image, it is determined whether or not the joint line is the second joint line according to the degree of the blood vessel amount in the blood vessel amount detection range S2 located at the upper side of the image. Thus, even if the image pickup range does not have a range in which part of the finger from the first joint to the second joint is set in, it can be determined whether or not a region near the second joint between the first joint and the second joint is located at the center of an image by the existence of a joint line. As a result, the authentication device 1 capable of improving the degree of freedom in setting the image pickup range can be realized.

### (4) Other Embodiments

In the above-described embodiments, an extraction unit (pattern extraction unit 21) extracts a figuration pattern of a blood vessel in the inside of the finger as a line, to which the present invention is not restricted, and a figuration pattern of a blood vessel may be extracted as a point.

Specifically, after extracting a figuration pattern of a blood vessel as a line (blood vessel line), the end point, branching point, and bending point of the blood vessel line are extracted by employing an extraction method referred to as the Harris corner, or an extraction method disclosed in Japanese Patent Application No. 2007-46089.

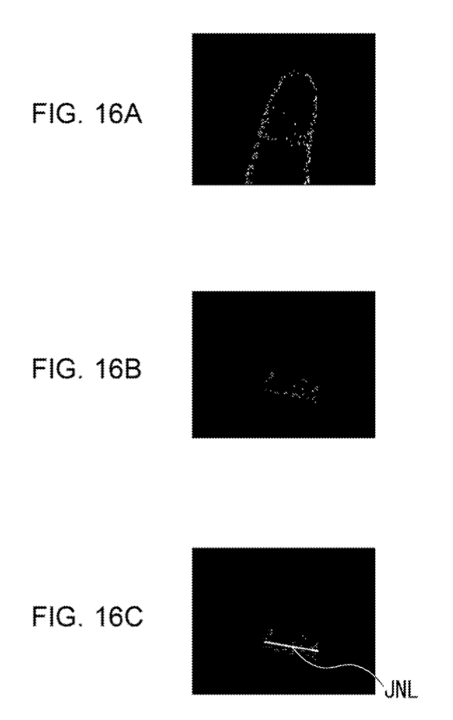

In case of extracting a point, the noise elimination unit 22 can be omitted, and, as shown in FIGS. 16A to 16C, the joint line detection unit 23 extends a group of points corresponding to transverse wrinkle components (horizontal direction) from a group of points extracted by the pattern extraction unit 21 by employing the Hough transformation, etc., and detects a line segment passing through substantially the center of thus extended group of points as a joint line JNL. In this way, effects similar to those in the above-described embodiments can be obtained.

Furthermore, as an identification subject, in the above-described embodiment, a blood vessel in the inside of the finger is employed, to which the present invention is not restricted, and a nerve in the inside of the finger or a fingerprint on the surface of the finger may be employed. In case of employing a fingerprint, by executing the above-described image processing with respect to image data which is obtained by irradiating a near infrared ray to the finger to pick up an image thereof, effects similar to those in the above-described embodiments can be obtained.

Moreover, in the above-described embodiment, from an image which is obtained as the image pickup result by the image pickup unit 12, a figuration pattern of a blood vessel of the finger reflected on the image is extracted (FIGS. 3A and 3B), and a joint line in the finger is detected, to which the present invention is not restricted, and there may be employed a configuration in which the focal point is controlled to be switched to a blood vessel or the surface of the finger, and a figuration pattern of a blood vessel is extracted from an image picked up when the blood vessel is brought to a focus, while a joint line is detected from an image picked up when the surface of the finger is brought to a focus.

In the control method, for example, the control unit 10 estimates the distance to a blood vessel or to the surface of the finger based on the contrast or phase of an image obtained as the image pickup result by the image pickup unit 12, or sets the distance to a blood vessel or to the surface of the finger in a ROM, and shifts an optical lens in the image pickup unit 12 to a position corresponding to the distance.

In this way, when extracting a figuration pattern of a blood vessel, the figuration pattern can be extracted based on an image which has its blood vessel components highlighted in proportion to transverse wrinkle components. On the other hand, when detecting a joint line, the joint line can be detected based on an image which has its transverse wrinkle components highlighted in proportion to blood vessel components. Accordingly, both the accuracy in extracting the figuration pattern and the accuracy in detecting the joint line can be improved.

Furthermore, in the above-described embodiment, the threshold value of a blood vessel amount set with respect to the blood vessel amount detection range S2 is fixed, to which the present invention is not restricted, and the threshold value of a blood vessel amount may be variable according to the waveform state of the luminance histogram.

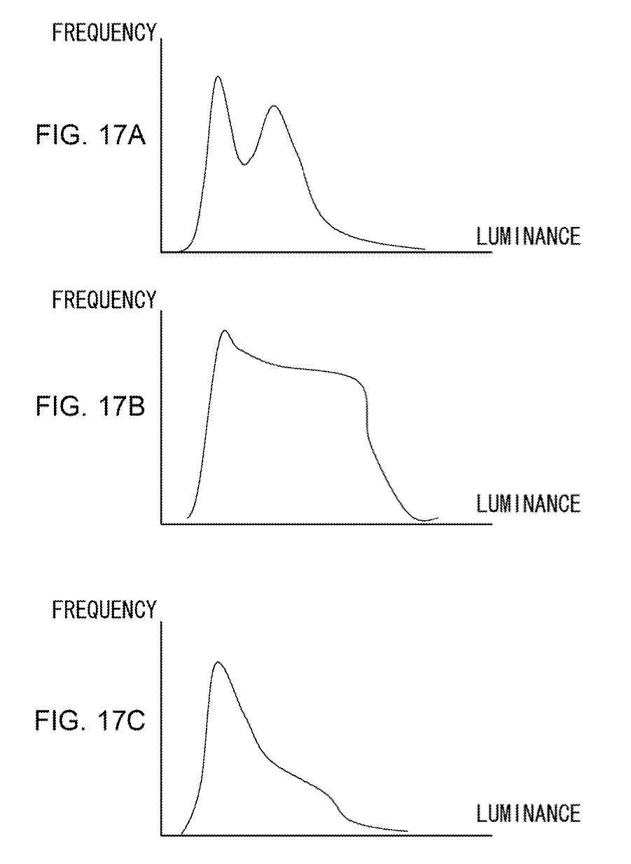

The relationship between the waveform state of the luminance histogram and the difficulty in reflecting a blood vessel will foe described. In general, it is known that the degree of difficulty in reflecting a blood vessel becomes different according to biological body elements such as sex, race, age, constitution of a biological body. On the other hand, the waveform state of the luminance histogram becomes different when the biological body elements are different such as a biological body in which the bone is thin and the amount of body fat is large (FIG. 17A), a biological body in which the bone is thick, and the amount of body fat is small (FIG. 17B), and a child (FIG. 17C), and can be classified roughly into several patterns. This has been confirmed by the present applicant already.

Accordingly, the degree of difficulty in reflecting a blood vessel can be specified to some extent according to the pattern of the waveform state of the luminance histogram.

In case of a waveform pattern in which the degree of the difficulty in reflecting a blood vessel is large, when the threshold value of a blood vessel amount with respect to the blood vessel amount detection range S2 is small, it is wrongly determined that the blood vessel line is not the second joint due to the difficulty in reflecting a blood vessel can be reduced as compared with a case in which the threshold value is fixed, even if a blood vessel line existing in the joint line detection range S1 is the second joint.

Specifically, the position determination unit 24 obtains a luminance histogram of an image represented by the image data D1 sent from the image pickup unit 12, and, when the waveform pattern of the luminance histogram is a waveform pattern in which the difficulty in reflecting a blood vessel is large, switches the threshold value of a blood vessel amount with respect to the blood vessel amount detection range S2 to a value which is reduced by a predetermined ratio with respect to the criterion value. In this way, when a joint line exists in the joint line detection range S1, it can further be correctly determined whether or not the joint line is the second joint line.

Furthermore, in the above-described embodiment, a case in which the size of the blood vessel amount detection range S2 is fixed is described, to which the present invention is not restricted, and the size of the blood vessel amount detection range S2 may be variable according to the waveform state of the luminance histogram.

Specifically, the position determination unit 24 obtains a luminance histogram of an image represented by the image data D1 sent from the image pickup unit 12, and, when the waveform pattern of the luminance histogram is a waveform pattern in which the difficulty in reflecting a blood vessel is large, switches the size of the blood vessel amount detection range S2 so that the size becomes large with respect to the criterion value. In this way, similar to the case in which the threshold value with respect to the blood vessel amount detection range S2 is variable, when a joint line exists in the joint line detection range S1, it can further be correctly determined whether or not the joint line is the second joint line.

Furthermore, in the above-described embodiment, pixels continuing in the vertical direction (up and down direction) with the focused pixel set to the center are fixed to five pixels (FIGS. 5A to 5C), to which the present invention is not restricted, and may be variable according to the waveform state of the luminance histogram.

Specifically, the position determination unit 24 obtains a luminance histogram of an image represented by the imago data D1 sent from the image pickup unit 12, and, when the waveform pattern of the luminance histogram is a waveform pattern in which the difficulty in reflecting a blood vessel is large, switches the number of pixels continuing in the vertical direction (up and down direction) with the focused pixel set to the center so that the number becomes small with respect to the criterion value. In this way, it becomes possible to generate an image which has its transverse wrinkle components further smoothed.

Furthermore, in the above-described embodiment, the above-described image processing is performed in accordance with a program stored in a ROM, to which the present invention is not restricted, and the above-described image processing may be performed in accordance with a program which is installed from a program storage medium such as a Compact Disc (CD), Digital Versatile Disc (DVD), a semiconductor memory, or a program which is downloaded from a program-providing server on the Internet.

Moreover, in the above-described embodiment, the above-described image processing is executed by the control unit 10, to which the present invention is not restricted, and part of the processing may be executed by a graphics workstation.

Moreover, in the above-described embodiment, the authentication device 1 provided with the image pickup function, collation function, and registration function is employed, to which the present invention is not restricted, and there may be employed a configuration in which, according to the use application, the respective functions or part of the functions are separated to single devices.

The present invention is applicable to the field of the biometric authentication.

It should be understood by those skilled in the art that various modifications, combinations, sub-combinations and alterations may occur depending on design requirements and other factors insofar as they are within the scope of the appended claims or the equivalents thereof.

What is claimed is:

1. An image determination device comprising:
extraction means for extracting a figuration pattern of an identification subject in a finger reflected on an image;
detection means for detecting a joint line in the finger; and
determination means for determining the image as an image to be registered or an image to be collated with a registration subject when a joint line exists in a first range which is set in one of respective regions obtained when separating the image with the center line that corresponds to a direction perpendicular to the longitudinal direction of the finger and that is set as the border, and a blood vessel amount which is equal to or more than a predetermined threshold value exists in a second range which is set in the other region different from the region in which the first range is set.

2. The image determination device according to claim 1, wherein
the identification subject is a blood vessel in the inside of the finger, and
the detection means detects the joint line from the image from which the blood vessel is extracted.

3. The image determination device according to claim 1, further comprising:
elimination means for eliminating wrinkle components along a direction perpendicular to the longitudinal direction of the finger from the image from which the blood vessel is extracted,
wherein,
from wrinkle components obtained from the difference between the image from which the blood vessel is extracted and the image from which the wrinkle components are eliminated, the detection means detects components which are high in continuity as the joint line.

4. The image determination device according to claim 1, further comprising:
setup means for, with respect to image pickup means, setting a first exposure value which is so prescribed as to pick up an image of an identification subject in the inside of a biological body, and a second exposure value which is so prescribed as to pick up an image of the surface of a biological body,
wherein,
the extraction means extracts the blood vessel from the image obtained from the image pickup means in which the first exposure value is set, and
the detection means detects the joint from the image obtained from the image pickup means in which the second exposure value is set.

5. The image determination device according to claim 1, wherein
the identification subject is a blood vessel in the inside of the finger, and
when the waveform pattern of a luminance histogram in the image is a waveform pattern in which the difficulty in reflecting a blood vessel is large, the determination means switches the threshold value with respect to the second range to a value which is reduced by a predetermined ratio with respect to the criterion value.

6. An image determination method comprising:
a first step of setting a first range in one of respective regions obtained when separating an image with the center line that corresponds to a direction perpendicular to the longitudinal direction of a finger reflected on the image and that is set as the border, and, in case a joint line of the finger does not exist in the set first range, setting the first range in the other region of the respective regions;
a second step of, when the joint line exists in the first range, setting a second range in the other region different from the region in which the first range is set; and
a third step of, when the joint line exists in the first range, and a blood vessel amount which is equal to or more than a predetermined threshold value exists in the second range, determining the image as an image to be registered or an image to be collated with a registration subject.

7. A program that makes a control unit controlling a work memory execute:
setting a first range in one of respective regions obtained when separating an image input to the control unit with the center line that corresponds to a direction perpendicular to the longitudinal direction of a finger reflected on the image and that is set to the border, and, in case a joint line of the finger does not exist in the set first range, setting the first range in the other region of the respective regions;
when the joint line exists in the first range, setting a second range in the other region different from the region in which the first range is set; and
when the joint line exists in the first range, and a blood vessel amount which is equal to or more than a predetermined threshold value exists in the second range, determining the image as an image to be registered or an image to be collated with a registration subject.

8. An image determination device comprising:
an extraction unit that extracts a figuration pattern of an identification subject in a finger reflected on an image;
a detection unit that detects a joint line in the finger;
a determination unit that determines the image as an image to be registered or an image to be collated with a registration subject when a joint line exists in a first range which is set in one of respective regions obtained when separating the image with the center line that corresponds to a direction perpendicular to the longitudinal direction of the finger and that is set as the border, and a blood vessel amount which is equal to or more than a predetermined threshold value exists in a second range which is set in the other region different from the region in which the first range is set.
